(19) United States
(12) Patent Application Publication
(10) Pub. No.: US 2007/0178323 A1
(43) Pub. Date: Aug. 2, 2007

(54) Polyimide multilayer body and method for producing same

(75) Inventors: Masami Yanagida, Shiga (JP); Hiroyuki Tuji, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, Osaka-shi, Osaka (JP)

(21) Appl. No.: 11/569,760

(22) PCT Filed: May 24, 2005
(86) PCT No.: PCT/JP05/09427

§ 371 Date: Nov. 29, 2006

(30) Foreign Application Priority Data
May 31, 2004 (JP) 2004-160729
Jul. 12, 2004 (JP) 2004-204633

(51) Int. Cl. B32B 27/00

(52) U.S. Cl. 428/473.5

(57) ABSTRACT

Disclosed is a polyimide laminate wherein a thermoplastic polyimide layer is formed on at least one side of a highly heat resistant polyimide layer. This polyimide laminate is characterized in that the highly heat-resistant polyimide layer contains molecules of a polyimide having a reactive functional group, and the thermoplastic polyimide layer contains molecules of a thermoplastic polyimide having a reactive functional group which is capable of forming at least one bond selected from an imide bond, amide bond and benzimidazole bond with the reactive functional group of the polyimide of contained in the highly heat-resistant polyimide layer. By having such an arrangement, the polyimide laminate is improved in the adhesion strength between the polyimides.

### TECHNICAL FIELD

The present invention relates to a polyimide multilayer body (polyimide laminate) applicable to flexible wired board, TAB tape, and the others, and a method for producing the same. More particularly, the present invention relates to a polyimide laminate in which a thermoplastic polyimide layer is formed on at least one side of a highly heat-resistant polyimide layer, and in which each layer is adhered with each other with greater adhesion strength.

### BACKGROUND ART

Recently, electronic products have been improved to be lighter in weight, smaller in size, and higher in density, thereby resulting in an increase in the demand for various types of substrates for printed boards, especially, the demand for flexible laminate (which may be referred to as flexible printed wired boards (hereinafter FPCs) or the like later). The flexible laminate have such a structure that a circuit is formed with a metal foil on an insulating film.

A flexible laminate is generally produced by adhering a metal foil on a substrate by heat and pressure applications with an adhesive material of various kinds therebetween. The substrate is an insulating film being flexible and made of an insulating material of various kinds. The insulating film is preferably a polyimide film or the like. The adhesive material is generally a heat-curable adhesive agent, which is epoxy-based, acryl-based, or the like. (The FPC in which such a heat-curable adhesive agent is used may be refereed to as a three-layered FPC).

The heat-curable adhesive agent is advantageous in that it allows adhesion at a relatively low temperature. However, it is expected that the three-layered FPCs cannot sufficiently satisfy future demands for better heat resistance, flexibility, and electric reliability. In view of this, FPCs in which a metal layer is formed directly on the insulting film, or in which the adhesive layer is made of a thermoplastic polyimide have been proposed (hereinafter, these FPCs may be referred to as two-layered FPCs). The two-layered FPCs show better characteristics than the three-layered, and higher demands for the two-layered FPCs are expected.

A flexible metal-clad board for a two-layered FPC may be prepared by a casting method, metalizing method, or a laminating method, for example. In the casting method, a polyamide acid, which is a precursor of a polyimide, is cast and spread on a metal foil and is imidized. In the metalizing method, a metal layer is formed directly on a polyimide film by sputtering or plating. In the laminating method, a polyimide film and a metal foil are adhered together via a thermoplastic polyimide. The laminating method is more excellent than the others because it can provide a wider range of thickness of the metal foil than does the casting method and requires a lower apparatus cost than the metalizing method. As an apparatus for the lamination, thermal roll laminating apparatus, double belt press apparatus or the like is used, in which materials in a rolled form are continuously unrolled to be fed in for the lamination. For better productivity, the thermal roll laminating method is more preferable among them.

A polyimide laminate in the laminating method has such a structure that a thermoplastic polyimide is laminated on a polyimide film as a core. In general, adhesion between a polyimide and a polyimide cannot be adhered with each other with high adhesion strength. Thus, the polyimide film, which is the core film, is generally subjected to a plasma processing, corona processing, or the like before the formation of the thermoplastic polyimide layer, in order to make the polyimide film more adhesive (for example, refer to Japanese Unexamined Patent Application Publication, Tokukai, No. 2004-51712 (Patent Citation 1)).

While this means allows adhering the polyimide with another polyimide with greater adhesion strength, this additionally requires the step for processing the polyimide film. This is a problem in view of productivity. Meanwhile, the adhesion is still not great enough and a further improvement therein is demanded.

Patent Citation 1: Japanese Unexamined Patent Application Publication, Tokukai, No. 2004-51712

### DISCLOSURE OF INVENTION

Technical Problem

An object of the present invention, which is accomplished in view of the aforementioned problems, is to provide a polyimide laminate in which a thermoplastic polyimide layer is adhered on at least one side of a highly heat-resistant polyimide layer with greater adhesion therebetween, and a method for producing the same.

Technical Solution

As a result of diligent studies, the inventors of the present invention found a novel laminate and a novel method for producing the same, which attain greater adhesion between a thermoplastic polyimide layer and a highly heat-resistant polyimide layer. The present invention is based on this finding.

More specifically, in one embodiment, a polyimide laminate according to the present invention includes: a highly heat-resistant polyimide layer; and a thermoplastic polyimide layer on at least one side of the highly heat-resistant polyimide layer, the highly heat-resistant polyimide layer containing molecules of a polyimide having a reactive functional group or reactive functional groups, and the thermoplastic polyimide layer containing molecules of a thermoplastic polyimide having a reactive functional group or reactive functional groups, each of which is respectively capable of forming a bond with the reactive functional group or reactive functional groups of the polyimide of the highly heat-resistant polyimide layer, each bond being independently at least one bond selected from the group consisting of an imide bond, an amide bond, and a benzimidazole bond.

Moreover, the polyimide laminate according to the present invention may be arranged such that each of the polyimides contained in the highly heat-resistant polyimide layer and the thermoplastic polyimide layer have one of the reactive functional group or reactive functional groups at its terminals. Furthermore, the polyimide laminate according to the present invention may be arranged such that each of the reactive functional group or reactive functional groups is a dicarboxylic anhydride group or an amino group, independently. Moreover, the polyimide laminate according to the present invention may contain a polyimide formed by bonding the polyimide contained in the highly heat-resistant polyimide layer with the polyimide contained in the thermoplastic polyimide layer. Furthermore, the polyimide laminate according to the present invention may contain a polyimide formed by bonding a terminal of the polyimide contained in the highly heat-resistant polyimide layer with a terminal of the polyimide contained in the thermoplastic polyimide layer.

In one embodiment, a method according to the present invention is a method for producing a polyimide laminate by a coextrusion-casting method, the polyimide laminate having a layer of a highly heat-resistant polyimide and a layer of a thermoplastic polyimide on at least one side of the layer of the highly heat-resistant polyimide. The method includes coextruding a solution containing a precursor of the highly heat-resistant polyimide, and a solution containing a precursor of the thermoplastic polyimide in order to cast the solutions onto a supporter. In the method, the precursor of the highly heat-resistant polyimide and the precursor of the thermoplastic polyimide having a reactive functional group or reactive functional groups respectively, each of which is capable of forming a bond therebetween, each bond being independently at least one bond selected from the group consisting of an imide bond, an amide bond, and a benzimidazole bond.

In one embodiment, a method according to the present invention is a method for producing a polyimide laminate by a coextrusion-casting method, the polyimide laminate having a layer of a highly heat-resistant polyimide and a layer of a thermoplastic polyimide on at least one side of the layer of the highly heat-resistant polyimide. The method includes coextruding a solution containing a precursor of the highly heat-resistant polyimide, and a solution containing the thermoplastic polyimide in order to cast the solutions onto a supporter. In the method, the precursor of the highly heat-resistant polyimide and the thermoplastic polyimide having a reactive functional group or reactive functional groups respectively, each of which is capable of forming a bond therebetween, each bond being independently at least one bond selected from the group consisting of an imide bond, an amide bond, and a benzimidazole bond.

Each method according to the present invention may be arranged such that each of the polyimides contained in the highly heat-resistant polyimide layer and the thermoplastic polyimide layer have one of the reactive functional group or reactive functional groups at its terminals. Moreover, each method according to the present invention may be arranged such that the reactive functional groups of the polyimides contained in the highly heat-resistant polyimide layer and the thermoplastic polyimide layer are capable of forming an imide bond therebetween.

### ADVANTAGEOUS EFFECTS

According to the present invention, it is possible to attain greater adhesion between a thermoplastic polyimide layer and a highly heat-resistant polyimide layer.

### BEST MODE FOR CARRYING OUT THE INVENTION

<Polyimide Laminate>

A polyimide laminate according to the present invention is a laminate in which a thermoplastic polyimide is provided on at least one side of a highly heat-resistant polyimide layer with greater adhesion, which is attained by reaction between molecules of a polyimide contained in the highly heat-resistant polyimide layer and molecules of a polyimide contained in the thermoplastic polyimide layer. Especially, greater adhesion or adhesion strength between the layers can be attained by connecting molecules of the polyimide of the highly heat-resistant polyimide layer and the molecules of the polyimide of the thermoplastic polyimide layer by reacting reactive functional groups at terminals of the polyimides. More specifically, greater adhesion can be attained by reacting reactive functional groups of the polyimides of the layers when the layers is laminated on one another, the reactive functional groups being respectively introduced to terminals of polyamide acids, which are precursors of the polyimides. Such a laminate may contain a reactive group left unreacted. The present invention is described below, referring to one exemplary embodiment thereof.

<1-1. Highly Heat-Resistant Polyimide Layer>

The highly heat-resistant polyimide layer according to the present invention is not particularly limited in terms of its molecular structure and thickness. However, it is preferable that the highly heat-resistant polyimide layer contain a non-thermoplastic polyimide resin by 90% by weight or more. The non-thermoplastic polyimide resin contained in the highly heat-resistant polyimide layer is generally produced from a polyamide acid as a precursor thereof. While the polyamide acid may be produced by any well-known method, the polyamide is generally produced by dissolving, in an organic solvent, an aromatic tetracarboxylic dianhydride and an aromatic diamine in substantially equimolar amounts, and stirring the thus prepared solution under controlled temperature condition until polymerization between the acid dianhydride and diamine is completed. Polyamide acid solutions thus prepared have a concentration in a range of 5% by weight to 35% by weight usually, and in a range of 10% by weight to 30% by weight preferably. With these ranges of the concentration, it is easy to attain an appropriate molecular weight and solution viscosity.

The polymerization may be carried out by any well-known method or any combination thereof. In the present invention, the method for the polymerization of the polyamide acid is characterized in an order in which the monomers are added. By controlling the order in which the monomers are added, properties of the resultant polyimide can be controlled. Therefore, any method may be adopted to add the monomers for the polymerization for the polyamide acid in the present invention.

Typical polymerization methods are described below, by way of example.

Method 1: The aromatic diamine is dissolved in an organic polar solvent, and is reacted with the aromatic tetracarboxylic dianhydride where the aromatic diamine and the aromatic tetracarboxylic dianhydride are in substantially equimolar amounts.

Method 2: In the organic polar solvent, the aromatic tetracarboxylic acid dianhydride is reacted with an aromatic diamine compound where the aromatic tetracarboxylic dianhydride is greater in molar amount than the aromatic diamine compound, thereby to obtain a prepolymer having acid dianhydride groups on its terminals; then, polymerization is carried out with the prepolymer and the aromatic diamine compound is further added in such an amount that makes up a substantially equimolar amount of the aromatic diamine compound in the overall process with respect to the aromatic tetracarboxylic dianhydride.

Method 3: In the organic polar solvent, the aromatic tetracarboxylic dianhydride is reacted with the aromatic diamine compound, where the aromatic diamine compound is greater in molar amount than the aromatic tetracarboxylic dianhydride, thereby to obtain a prepolymer having amino groups on its terminals; the aromatic diamine compound is further added to the prepolymer; polymerization is carried out with the prepolymer and the aromatic tetracarboxylic acid dianhydride is further added in such an amount that makes up a substantially equimolar amount of the aromatic tetracarboxylic dianhydride in the overall process with respect to the aromatic diamine compound.

Method 4: After the aromatic tetracarboxylic dianhydride is dissolved and/or dispersed in the organic polar solvent, polymerization is carried out with the thus prepared solution and the aromatic diamine compound is further added in such an amount that makes up a substantially equimolar amount of the aromatic diamine compound in the overall process with respect to the aromatic tetracarboxylic dianhydride.

5) A mixture of the aromatic tetracarboxylic dianhydride and aromatic diamine in substantially equimolar amounts is reacted in the organic polar solvent to polymerize the aromatic tetracarboxylic dianhydride and aromatic diamine.

These methods may be adopted solely or in a partial combination.

The present invention may use any polyamide acid prepared by any of these polymerization methods. The present invention is not limited to a particular polymerization method for the preparation of the polyamide acid.

In the present invention, it is also preferable to use a polymerization method in which a prepolymer is prepared from a diamine component having a rigid structure. With this method, it becomes easier to obtain a polyimide film having a high elasticity and a small expansion coefficient against absorption. In this method, the preparation of the prepolymer is carried out with (i) the diamine having a rigid structure and (ii) the acid dianhydride preferably in a molar ratio in a range of 100:70 to 100:99, or 70:100 to 99:100, and further preferable in a range of 100:75 to 100:90 or 75:100 to 90:100. If the acid dianhydride content was greater in the ratio than in these ranges, the modulus of elasticity and expansion coefficient against absorption would be hardly improved. If the acid dianhydride content was less in the ratio than in these ranges, problems such as too small linear expansion coefficient or small tensile expansion would possibly occur.

In the following, materials that can be used as the compositions of the polyamide acid according to the present invention are exemplified.

Examples of the tetracarboxylic dianhydride, which are appropriately applicable to the present invention include: pyromellitic dianhydride, 2,3,6,7-naphthalenetetracarboxylic dianhydride, 3,3′,4,4′-biphenyltetracarboxylic dianhydride, 1,2,5,6-naphthalenetetracarboxylic dianhydride, 2,2′,3,3′-biphenyltetracarboxylic dianhydride, 3,3′4,4′-benzophenonetetracarboxylic dianhydride, 4,4′-oxyphthalic dianhydride, 2,2-bis(3,4-dicarboxyphenyl)propane dianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxylphenyl)methane dianhydride, bis(3,4-dicarboxyphenyl)ethane dianhydride, oxydiphthalic dianhydride, bis(3,4-dicarboxyphenyl)sulfone dianhydride, p-phenylenebis(trimellitic monoester acid anhydride), ethylenebis(trimellitic monoester acid anhydride), bisphenol Abis(trimellitic monoester acid anhydride), and similar compounds. These compounds may be used solely or in combination in an arbitrary ratio.

Of these acid dianhydrides, it is preferable to use at least one acid dianhydride selected from the group consisting of pyromellitic dianhydride, 3,3′,4,4′-benzophenonetetracarboxylic dianhydride, 4,4′-oxyphthalic dianhydride, and 3,3′,4,4′-biphenyltetracarboxylic dianhydride.

In case of using at least one acid dianhydride selected from the group consisting of 3,3′,4,4′-benzophenonetetracarboxylic dianhydride, 4,4′-oxyphthalic dianhydride, and 3,3′,4,4′-biphenyltetracarboxylic dianhydride, the selected dianhydride(s) is used in an amount of 60 mol % or less, preferably 55 mol % or less, and further preferably 50 mol % or less with respect to a total amount of the acid dianhydrides used. In case of using at least one acid dianhydride selected from the group consisting of 3,3′,4,4′-benzophenonetetracarboxylic dianhydride, 4,4′-oxyphthalic dianhydride, and 3,3′,4,4′-biphenyltetracarboxylic dianhydride, an amount of the selected at least one acid dianhydride exceeding the these ranges results in a polyimide film whose glass transition temperature is too low, or the amount results in an excessively low storage modulus of elasticity at high temperature. Whereby, it becomes difficult to form the polyimide film.

In case where pyromellitic dianhydride is used, an amount of pyromellitic dianhydride to be used is preferably in a range of 40 to 100 mol %, further preferably in a range of 45 to 100 mol %, and especially preferably in a range of 50 to 100 mol %. The use of pyromellitic dianhydride in these ranges makes it easy to keep the glass transition temperature and the storage modulus of elasticity at high temperatures as appropriate for the usage or film formation.

Examples of the diamine appropriately applicable as compositions of the polyamide acid, which is the precursor of the heat resistant polyimide according to the present invention include: 4,4′-diaminodiphenylpropane, 4,4′-diaminodiphenylmethane, benzidine, 3,3′-dichlorobenzidine, 3,3′-dimethylbenzidine, 2,2′-dimethylbenzidine, 3,3′-dimethoxybenzidine, 2,2′-dimethoxybenzidine, 4,4′-diaminodiphenylsulfide, 3,3′-diaminodiphenylsulfone, 4,4′-diaminodiphenylsulfone, 4,4′-oxydianiline, 3,3′-oxydianiline, 3,4′-oxydianiline, 1,5-diaminonaphthalene, 4,4′-diaminodiphenyldiethylsilane, 4,4′-diaminodiphenylsilane, 4,4′-diaminodiphenylethylphosphineoxide, 4,4′-diaminodiphenyl-N-methylamine, 4,4′-diaminodiphenyl N-phenylamine, 1,4-diaminobenzene(p-phenylenediamine), 1,3-diaminobenzene, 1,2-diaminobenzene, bis{4-(4-aminophenoxy)phenyl}sulfone, bis{4-{4-aminophenoxy}phenyl}propane, bis{4-(3-aminophenoxy)phenyl}sulfone, 4,4′-bis(4-aminophenoxy)biphenyl, 4,4′-bis(3-aminophenoxy)biphenyl, 1,3-bis(3-aminophenoxy)benzene, 1,3-bis(4-aminophenoxy)benzene, 1,3-bis(4-aminophenoxy)benzene, 1,3-bis(3-aminophenoxy)benzene, 3,3′-diaminobenzophenone, 4,4′-diaminobenzophenone, and similar compounds.

The diamine component may contain a diamine having a rigid structure and an amine having a soft structure in a molar ratio preferably in a range of 80/20 to 20/80, more preferably in a range of 70/30 to 30/70, and especially preferably in a range of 60/40 to 30/70. If the ratio of the diamine having the rigid structure is higher than the ranges, the resultant film tends to have a small tensile elongation. If the ratio of the diamine having the rigid structure is lower than the ranges, the glass transition temperature would possibly become too low, or the storage modulus of elasticity at a high temperature would possibly be excessively low to make it difficult to form the film.

The diamine having a rigid structure in the present invention is represented by the following general formula (1):
NH₂—R₂—NH₂ general formula (1),
where R₂ is a divalent aromatic group selected from the general formula group (1) consisting of: 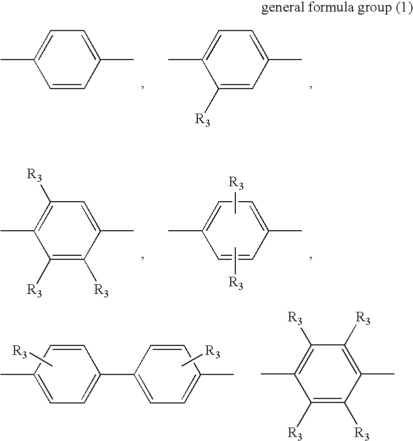
where each R₃ is identically or independently, one group selected from the group consisting of —H, —CH₃, —OH, CF₃, —SO₄, —COOH, —CO—NH₂, —Cl, —Br, —F, and —OCH₃.

The diamine having a soft structure is a diamine having a soft structure, such as an ether group, sulfone group, ketone group, sulfide group or the like. Preferably, the diamine having a soft structure is represented by the following general formula (2): 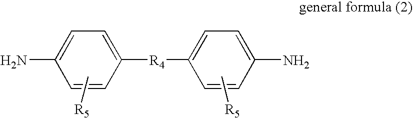
where R₄ is a divalent organic group selected from the general formula group (2) the group consisting of: 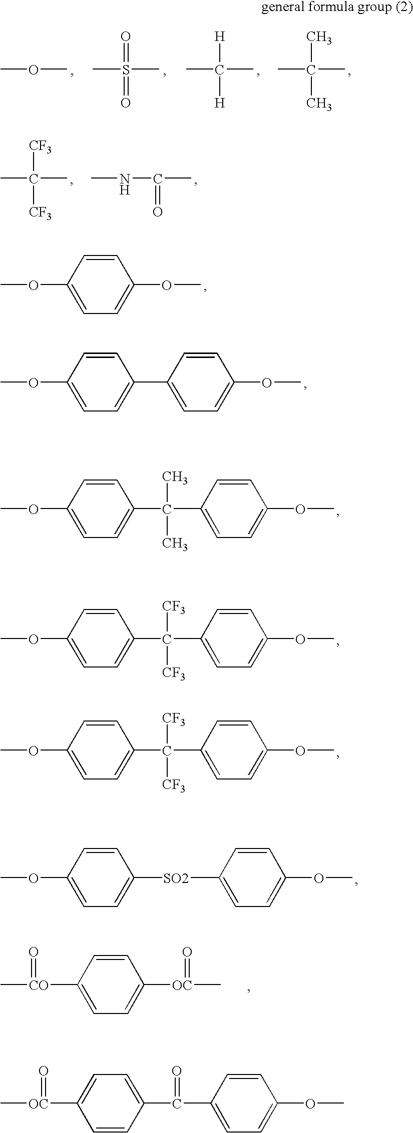
where each R₅ is identically or independently one group selected from the group consisting of —H, —CH₃, —OH, CF₃, —SO₄, —COOH, —CO—NH₂, —Cl, —Br, —F, and —OCH₃.

The polyimide film used in the present invention can be suitably obtained by appropriately selecting the kinds and mixing ratio of the aromatic acid dianhydride and aromatic diamine within the range, such that the film has desired properties.

The solvent for the synthesis of the polyamide acid may be any solvent which dissolves the polyamide acid therein. Preferable examples of the solvent include amide-based solvents, typically, N,N-dimethylformamide, N,N-dimethylacetamide, N-methyl-2-pyrrolidone, and the like. N,N-dimethylformamide, and N,N-dimethylacetamide are especially preferable.

In order to attain greater adhesion between the layers in the polyimide laminate according to the present invention, it is preferable that the molecules of the non-thermoplastic polyimide contained in the highly heat-resistant polyimide layer be reacted with the molecules of the thermoplastic polyimide contained in the thermoplastic polyimide layer. Especially, it is preferable that the molecules of the polyimides are reacted at their terminals. One specific example of this arrangement is such that a reactive group(s) is introduced to terminals of polyamide acids, which are respectively the precursors of the polyimides, and the reactive group at the terminal of one polyimide is reacted with the reactive group at the terminal of the other polyimide after the lamination is carried out. Therefore, it is preferable that the preparation of the non-thermoplastic polyimide in the highly heat-resistant polyimide layer include introducing the reactive functional group at a terminal of the polyamide acid from which the polyimide is obtained.

In view of dynamical properties, durability, and the like of the polyimide laminate, it is essential that bonds formed as a result of the reaction is at least one selected from the group consisting of an imide bond, an amide bond, and a benzimidazole bond. Preferable examples of the reactive functional groups include hydroxyl group, diaminophenyl group, amino group, carboxylic acid group, dicarboxylic anhydride group, and the like. For easy introduction of the reactive functional group(s) to the terminal, the reactive functional group(s) is preferably at least one selected from the group consisting of amino group, carboxylic acid group, and dicarboxylic anhydride group.

Specific examples of the method for introducing the functional group(s) to the terminal are:

1) The polyamide acid is prepared to have an amino group or dicarboxylic anhydride group at its terminal by controlling the order in which the monomers are added; and

2) The reactive functional group is introduced at the terminal of the polyamide acid by a known synthetic reaction after the polyamide acid is formed; and the like method.

Considering the production cost, especially preferable is the method in which the polyamide acid is prepared to have an amino group or dicarboxylic anhydride group at its terminal by controlling the order in which the monomers are added. With this method, the polyamide acid will have a dicarboxylic anhydride terminal if the monomer added at last is diamine, but an amino group terminal if the monomer added at last is tetracarboxylic dianhydride.

Moreover, a filler may be added in order to improve the film in terms of its properties such as slidability, heat conductivity, electric conductivity, corna resistance, loop stiffness, etc. Any filler may be added. Preferable examples of the filler include silica, titanium oxide, alumina, silicon nitride, boron nitride, calcium hydrogenphosphate, calcium phosphate, mica, and the like.

The filler is not particularly limited in terms of its particle diameter, because the particle diameter is selected depending on the film property to be modified and the kind of the filler to be added. In general, the filler has an average particle diameter in a range of 0.05 μm to 100 μm, preferably in a range of 0.1 μm to 75 μm, further preferably in a range of 0.1 μm to 50 μm, especially preferably in a range of 0.1 μm to 25 μm. The modification of the property becomes difficult with particle diameters below these ranges, meanwhile, surface properties and mechanical properties would be possibly deteriorated largely with particle diameters above these ranges. Moreover, the filler is not limited in terms of how much amount (by parts) it is added, because the amount (by parts) of the filler is selected depending on the film property to be modified and the kind of the filler to be added. Generally, the filler is added in an amount in a range of 0.01 parts by weight to 100 parts by weight, preferably in a range of 0.01 parts by weight to 90 parts by weight, and further preferably in a range of 0.02 parts by weight to 80 parts by weight with respect to the polyimide of 100 parts by weight. If the filler is added in an amount below the ranges, the modification by the filler becomes difficult. The mechanical properties of the film would be possibly deteriorated if the filler is added in an amount above the ranges.

The filler may be added by any method, for example:

1) The filler is added into a polymerization reaction solution before or during the polymerization;

2) The filler is mixed in by using three rolls or the like after the completion of the polymerization; or

3) A dispersion solution containing the filler is prepared and added into a solution of the polyamide acid and an organic solvent.

The method in which a dispersion solution containing the filler is prepared and added into a solution of the polyamide acid is preferable, especially if the dispersion solution is added in immediately before the formation of the film. This is because pollution of a production line by the filler is least severe in this method compared with the other methods. It is preferable that the dispersion solution containing the filler be prepared with the same solvent as the polymerization solution of the polyamide acid. For attaining excellent dispersion and stabilizing the dispersion state, a dispersing agent, thickener, and/or the like may be added as long as it does not affect the film properties.

The thus prepared solution containing the precursor of the non-thermoplastic polyimide resin is also referred to as a solution containing the precursor of the highly heat-resistant polyimide.

<1-2. Thermoplastic Polyimide Layer>

The thermoplastic polyimide layer according to the present invention is not particularly limited in terms of thermoplastic polyimide resin content in the layer, a molecular structure of the thermoplastic polyimide resin, and the thickness of the layer, as long as the thermoplastic polyimide layer shows significant adhesion power in the lamination method. However, it is preferable that the thermoplastic polyimide resin content be substantially 50% by weight or more, for attaining the significant adhesion power.

As the thermoplastic polyimide contained in the thermoplastic polyimide layer, a thermoplastic polyimide, a thermoplastic polyamideimide, a thermoplastic etherimide, a thermoplastic polyesterimide, and the like are suitable. Of them, the thermoplastic polyesterimide is especially suitable.

The thermoplastic polyimide contained in the thermoplastic polyimide layer according to the present invention is prepared by conversion reaction from the polyamide acid, which is the precursor thereof. The preparation of the polyamide acid may be carried out by any well-known method, like the precursor of the highly heat-resistant polyimide layer.

In order that the thermoplastic polyimide layer may be laminated by using an existing apparatus, and may not deteriorate the heat resistance of the metal-clad laminate, the thermoplastic polyimide according to the present invention preferably has its glass transition temperature (Tg) in a range of 150° C. to 300° C., where Tg is determined by a point of infection of the storage modulus of elasticity measured by using a dynamic viscoelastisity measuring apparatus (DMA).

The polyamide acid, which is the precursor of the thermoplastic polyimide for use in the present invention, is not particularly limited and may be any well-known polyamide acid. The polyamide acid may be produced with the raw materials and manufacturing conditions etc. described above.

Properties of the thermoplastic polyimide can be adjusted by variously selecting raw materials to be used in combination. In general, a larger ratio of the diamine of the rigid structure is not preferably because it gives a higher glass transition temperature, and/or a larger storage modulus of elasticity at high temperatures, whereby the resultant thermoplastic polyimide becomes poor in adhesiveness and processability. The ratio of the diamine of the rigid structure is preferably 40 mol % or less, more preferably 30 mol % or less, and especially preferably 20 mol % or less.

One specific example of the preferable thermoplastic polyimide resin is a resin prepared by polymerization of (i) an acid dianhydride containing a biphenyltetracarboxylic dianhydride, and (ii) a diamine having an aminophenoxy group.

Like the molecules of the polyimide contained in the highly heat-resistant polyimide layer, the molecules of the polyimide contained in the thermoplastic polyimide layer are also prepared from the polyamide acid (the precursor thereof) having a reactive group. It is necessary that the molecules of the polyimide be prepared from the polyamide acid. The introduction of the reactive functional group may be carried out by the same method as the methods described in <1-1. Highly heat-resistant Polyimide Layer>. It is also preferable that the molecules of polyimide contained in the thermoplastic polyimide layer be molecules of polyimide prepared from the polyamide acid having a reactive functional group at its terminal.

Furthermore, in order to control the properties of the polyimide laminate according to the present invention, the highly heat-resistant polyimide layer and/or the thermoplastic polyimide layer may contain inorganic or organic filler, or other resin if necessary.

<1-3. Combinations of Reactive Functional Groups of Molecules of Polyimides of Layers>

Examples of combinations of the reactive functional groups that allow the bonding between the molecules of the polyimides of the heat resistant polyimide layer and thermoplastic polyimide layer in the present invention include: amino group and dicarboxylic anhydride, diamine and carboxylic acid, amino group and carboxylic acid, and the like.

<2. Production of Polyimide Laminate>

Examples of the method for producing the polyimide laminate include: (1) the highly heat-resistant polyimide layer is prepared in advance, the solution of the polyamide acid, which is the precursor of the thermoplastic polyimide, is applied thereon by coating, dipping, or the other process, and the solution of the polyamide acid is heated for imidation so as to form the thermoplastic polyimide layer; (2) the highly heat-resistant polyimide layer is prepared, and a solvent-dissoluble thermoplastic polyimide is formed thereon; (3) the highly heat-resistant polyimide layer and the thermoplastic polyimide layer are prepared independently, and then adhered together; (4) a solution containing the precursor of the highly heat-resistant polyimide and a solution containing the thermoplastic polyimide or the precursor thereof are cast in layers in a liquid state on a supporter (a metal drum, metal belt, or the like) by a coextrusion-casting method, so as to obtain a self-supportable dried film, and then the self-supportable dried film is heated for imidation; (5) the precursor of the highly heat-resistant polyimide layer is cast to obtain a self-supportable dried film, a solution of the polyamide acid, which is the precursor of the thermoplastic polyimide is applied on the self-supportable dried film by coating, dipping, or the other process, and then the solution of the polyamide acid and the self-supportable dried film are heated for imidation; (6) and the like methods.

However, most preferable is a method in which an adhesive layer containing thermoplastic polyimide is formed on at least one side of the highly heat-resistant polyimide layer by the coextrusion-casting method. This is because this method can attain the effect of the present invention most significantly. In this method, each layer containing the polyamide acid is laminated, so it is possible to attain efficient reaction of the reactive functional groups in the imidation.

In any of these methods, the imidation is essential. The imidation may be carried out thermally only heat application or chemically by using a dehydrogenating agent and a catalyst. Any of these methods can be adopted. In either of these methods, heat is applied to facilitate the imidation. In the heating, the temperature is set preferably in a range of (the glass transition temperature of the thermoplastic polyimide−100° C.) to (the glass transition temperature+200° C.), and more preferably in a range of (the glass transition temperature of the thermoplastic polyimide−50° C.) to (the glass transition temperature+150° C.). A higher thermal curing temperature facilitates the imidation thereby speeding up the curing. Thus, such a higher thermal curing temperature is more preferable in view of productivity. However, thermolysis of the thermoplastic polyimide would possibly occur if the thermal curing temperature is too high. On the other hand, the imidation would proceed at a slow rate even by the chemical curing and thus the curing would take a long time if the temperature of the thermal curing is too low.

The imidation should be long enough to complete the imidation and drying substantially. So, various factors are involved in determining the time of the imidation. In general, the time of the imidation is appropriate in a range of the order of 1 sec to 600 sec. Moreover, the imidation ratio may be kept low, and/or the solvent may be remained purposely in order that the adhesive layer has a higher fluidability when the adhesive layer is in a melting state.

Tension applied in the imidation is preferable in a range of 1 kg/m to 15 kg/m, and especially preferable in a range of 5 kg/m to 10 kg/m. Tension lower than these ranges would cause sagging or meandering, which would possibly result in problems such as shrinkage or unevenness in the film when rolling up the film. On the other hand, tension higher than these ranges would result in poor property of the resultant metal-clad flexible laminate in terms of its size, because the laminate with high tension applied thereon is heated at a high temperature.

The method according to the present invention for producing the polyimide laminate is explained in more detail. In the method according to the present invention for producing the polyimide laminate, the coextrusion-casting method is such a film producing method that includes feeding concurrently into a coextruder having a dice for extruding out two or more layer a solution containing a precursor of the highly heat-resistant polyimide and a solution containing the thermoplastic polyimide and or the precursor thereof, and extruding the solutions from the outlet of the dice to form a two-or-more layered thin film. In general, this method is carried out in the following manner: Both the solution extruded out from the dice for the extrusion of two or more layers are continuously on a flat supporter to form a multilayer thin film thereon, From the multilayer thin film at least part of the solvent is distilled off thereby to form self-supportable multilayer film. Further, the multilayer film is peeled off from the supporter and heated at a high temperate (in a range of 250° C. to 600° C. to remove the solvent off substantially and proceed the imidation. Thereby, the desired adhesive film is obtained. Moreover, the imidation ratio may be kept low, and/or the solvent may be remained purposely in order that the adhesive layer has a higher flowability when the adhesive layer is in a melting state.

In general, the polyimide is obtained by dehydration and conversion reaction of the precursor thereof, that is, the polyamide acid. Most well known as the conversion reaction are: the heat curing method in which the curing is facilitated only by heat application; and the chemical curing method in which a chemical dehydrator is used. For efficient production, the chemical curing is more preferable.

Here, a chemical curing agent contains a dehydrating agent and a catalyst. The dehydrating agent is a dehydrating and ring-closing agent for the polyamide acid. As to its main component, the chemical curing agent may preferably contain at least one of aliphatic acid anhydrides, aromatic acid anhydrides, N,N′-dialkylcarbodimide, lower aliphatic halides, halogenated lower aliphatic acid anhydride, allyl sulfonic acid dihalides, thionyl halides. Among these compounds, the aliphatic acid anhydrides and aromatic acid anhydrides are more preferable. The catalyst is a component that can facilitate the dehydrating and ring-closing function of the curing agent to the polyamide acid. For example, aliphatic tertiary amines, aromatic tertiary amines, and heterocyclic tertiary amines may be the catalyst. Of these compounds, nitrogen-containing heterocyclic compounds such as imidazole, benzimidazole, isoquinoline, quinoline, and β-picoline are preferable as the catalyst. Furthermore, an organic polar solvent may be added to a solution of the dehydrating agent and the catalyst.

How to carry out the vaporizing of the solvent(s) from the solution containing the precursor of the highly heat-resistant polyimide and the containing the thermoplastic polyimide or the precursor thereof is not particularly limited. However, it is easiest to carry out the vaporizing by heating and/or air flow. In the heating, too high temperatures would cause sudden vaporizing that causes dents where the solvent is suddenly volatilized, thereby forming minute defects in the resultant adhesive film. Therefore, it is preferably that the temperature in the heating for the vaporizing be higher than the boiling point of the solvent(s) by 50° C. or less.

### EXAMPLES

Next, the method for producing the polyimide laminate according to the present invention is described in more details. Strength of the adhesion between polyimides of polyimide laminates in Synthetic Example, Examples, and Comparative Examples was evaluated as below.

(Strength of Adhesion)

Samples were prepared according to JIS C6471 “6.5 Peeling Strength”. Load for pealing a metal foil portion of 5 mm width at a peeling angle of 90° at a rate of 50 mm/min was measured.

### Synthetic Example 1

Into a glass flask of 2000 ml capacity, 780 g of DMF, 78.7 g of 3,3′,4,4′-biphenyltetracarboxylic dianhydride (BPDA), 5.8 g of ethylene bis(trimellitic monoester acid anhydride (TMEG) were added and stirred for 1 hour under nitrogen atmosphere and then for 30 min in an ice bath. After that, 111.7 g of 2,2-bis[4-(4-aminophenoxy)phenyl]propane (BAPP) was added therein. In the reaction solution thus prepared, a solution in which 3.3 g of BAPP was dissolved in 20 g of DMF was gradually added and stirred, monitoring viscosity of the reaction solution. When the viscosity of the reaction solution reached 2000 poise, the addition and stirring were stopped, whereby a solution of a polyamide acid was obtained.

The solution of a polyamide acid was cast on a 25 μm PET film (Serapeel HP, Toyo Metalizing Co. Ltd.) in such a manner that a layer of 25 μm would be obtained thereon at the end, and was dried at 120° C. for 5 min. After the drying, the self-supportable film was peeled off from the PET and fixed on a metal pin frame. Then, the self-supportable film was dried at 150° C. for 5 min, 200° C. for 5 min, 250° C. for 5 min, and then at 350° C. for 5 min, thereby obtaining a single-layered sheet. The thermoplastic polyimide thus obtained has a glass transition temperature of 240° C. Thermoplastic property test showed that the layer of polyimide was shrunk to be eternally deformed. This proved that the polyimide was thermoplastic.

### Synthetic Example 2

Into a glass flask of 2000 ml capacity, 780 g of DMF, and 115.6 g of 2,2-bis[4-(4-aminophenoxy)phenyl]propane (BAPP), were added and stirred under nitrogen atmosphere with 78.7 g of 3,3′,4,4′-biphenyltetracarboxylic dianhydride (BPDA) gradually added therein. After 3.8 g of ethylene bis(trimellitic monoester acid anhydride) (TMEG) was added therein, the solution was stirred for 30 min in an ice bath. In the reaction solution thus prepared, a solution in which 2.0 g of TMEG was dissolved in 20 g of DMF was gradually added and stirred, monitoring viscosity of the reaction solution. When the viscosity of the reaction solution reached 2000 poise, the addition and stirring were stopped, whereby a solution of a polyamide acid was obtained.

The solution of a polyamide acid was cast on a 25 μm PET film (Serapeel HP, Toyo Metalizing Co. Ltd.) in such a manner that a layer of 20 μm would be obtained thereon at the end, and was dried at 120° C. for 5 min. After the drying, the self-supportable film was peeled off from the PET and fixed on a metal pin frame. Then, the self-supportable film was dried at 150° C. for 5 min, 200° C. for 5 min, 250° C. for 5 min, and then at 350° C. for 5 min, thereby obtaining a single-layered sheet. The thermoplastic polyimide thus obtained has a glass transition temperature of 240° C. Thermoplastic property test showed that the layer of polyimide was shrunk to be eternally deformed. This proved that the polyimide was thermoplastic.

### Synthetic Example 3

Into 229 kg of N,N-dimethylformamide (DMF) cooled down to 10° C., 6.20 kg of p-phenylenediamine (p-PDA) and 11.50 kg of 4,4′-oxydianiline (ODA) were dissolved. Then, 18.50 kg of benzophenonetetracarboxylic dianhydride (BTAD) was added and dissolved therein. Further, 15.79 kg of p-phenylene bis(trimellitic monoester acid anhydride (TMHQ) was dissolved therein. Then, 4.01 kg of pyromellitic dianhydride (PMDA) was added therein and then stirred for 1 hour to dissolve completely. Into the reaction solution thus prepared, a solution in which PMDA was dissolved in DMF (PMDA:DMF=1.0 kg:14 kg) was gradually added until viscosity of the reaction reached 3000 poise approximately. The reaction solution was then stirred for 1 hour thereby obtaining a solution of a polyamide acid whose solid content was 19% by weight, and rotational viscosity was 3400 poise at 23° C.

### Synthetic Example 4

Into 240 kg of N,N-dimethylformamide (DMF) cooled down to 10° C., 18.50 kg of benzophenonetetracarboxylic dianhydride (BTDA) was dissolved. Then, 15.90 kg of p-phenylene bis(trimellitic monoester acid anhydride (TMHQ) was added and dissolved therein. Further, 15.79 kg of p-phenylene bis(trimellitic monoester acid anhydride) (TMHQ) was dissolved therein. Then, 5.01 kg of pyromellitic dianhydride (PMDA) was added therein and then stirred for 1 hour to dissolve completely. Into the reaction solution thus prepared, 6.20 kg of p-phenyleneamine (p-PDA) and 11.0 kg of 4,4′-oxydianiline (ODA) were dissolved and then a solution in which p-PDA was dissolved in DMF (p-PDA:DMF=0.22 kg:3 kg) was gradually dissolved until viscosity of the reaction reached 3000 poise approximately. The reaction solution was then stirred for 1 hour thereby obtaining a solution of a polyamide acid whose solid content was 19% by weight, and rotational viscosity was 3400 poise at 23° C.

<Preparation of Copper-Clad Laminate 1>

Described below is a preparation of a copper-clad laminate in which a highly heat-resistant polyimide layer was coated with a thermoplastic polyamide acid, and then subjected to imidation thereby to prepare a polyimide laminate.

Into solutions of the polyamides acid which were obtained in Synthetic Examples 3 and 4 respectively and were the precursors of the highly heat-resistant polyimides, a chemical curing agent whose composition was acetic anhydride/isoquinoline/DMF (in a weight ratio of 18.90/7.17/18.93) was added continuously in an amount of 50% by weight with respect to an amount of the solution of polyamide acid with stirring by a mixer. The solutions thus prepared were respectively extruded via a T die to be cast onto a stainless endless belt running 20 mm under the die. The resin films thus prepared were heated at 130° C. for 100 sec, thereby obtaining self-supportable gel films, respectively. The self-supportable gel films were peeled off (volatile content: 45% by weight) from the stainless endless belt. Then, the self-supportable gel films were fixed on tenter clips, and dried at 300° C. for 20 sec, 450° C. for 20 sec, and 500° C. for 20 see for drying and imidation. Thereby, 17 μm highly heat-resistant polyimide layer were obtained, respectively.

Next, the solutions of the polyamide acids, which were the precursors of the thermoplastic polyimides and were obtained in Synthetic Examples 1 and 2 were diluted with DMF to solid content of 10% by weight, respectively. Then, the thus diluted solutions of the polyamide acids were applied on both sides of each above-mentioned heat resistant polyimide layer in such a way that a thermoplastic polyamide layer of 3 μm thickness would be formed on each side. Then, the thus prepared laminates were heated at 140° C. for 1 min. After that, the laminates were passed through a far infrared heater at 390° C. for 20 see for thermal imidation. Thereby, polyimide laminates were obtained.

On each side of the thus prepared polyimide laminates, a 18 μm rolled copper foil (BHY-22B-T, Japan Energy Corp.) and Apical 125 NPI (Kaneka Corp.) on top of each copper foil were thermally laminated continuously with a polyimide laminate's tension of 0.4N/cm, lamination temperature of 380° C. and lamination pressure of 196N/cm (20 kgf/cm) at lamination speed 1.5 m/min. The Apical 125NPI was a protective material. By such thermal lamination, flexible copper-clad laminates (FCCLs).

<Preparation of Copper-Clad Laminate 2>

Preparation of a copper-clad laminate in which a polyimide laminate was prepared by coextrusion-casting method is described below.

Into each of the solutions of polyamide acids, which were the precursors of the highly heat-resistant polyimide and were prepared in Synthetic Examples 3 and 4, the following chemical dehydrating agent and a catalyst were added.

1. Chemical Dehydrating Agent: two moles of acetic anhydride per one mole of amide acid unit of the polyamide acid, which was the precursor of the highly heat-resistant polyimide.

2. Catalyst: one mole of isoquinoline per one mole of amide acid unit of the polyamide acid, which was the precursor of the highly heat-resistant polyimide.

Into each of the solutions of polyamide acids, which were the precursors of the highly heat-resistant polyimide and were prepared in Synthetic Examples 1 and 2, the following chemical dehydrating agent and a catalyst were added.

1. Chemical Dehydrating Agent: two moles of acetic anhydride per one mole of amide acid unit of the polyamide acid, which was the precursor of the thermoplastic polyimide.

2. Catalyst: two mole of isoquinoline per one mole of amide acid unit of the polyamide acid, which was the precursor of the thermoplastic polyimide.

Next, the solutions of the polyamides were continuously extruded from a three-layer multimanifold T die to be cast onto a stainless endless belt running 20 mm under the T die. Each solution was extruded in such an order that the solution of the polyamide, which was the precursor of the thermoplastic polyimide, formed an outer layer while the solution of the polyamide, which was the precursor of the highly heat-resistant polyimide, formed an inner layer. The resin films thus prepared were heated at 130° C. for 100 sec, thereby obtaining self-supportable gel films, respectively. The self-supportable gel film was peeled off from the stainless endless belt. Then, the self-supportable gel film was fixed on tenter clips, and dried at 300° C. for 30 sec, 400° C. for 50 sec, and 450° C. for 10 sec for drying and imidation. Thereby, laminate having a thermoplastic polyimide layer of 3 μm and a highly heat-resistant polyimide layer of 17 μm was obtained.

On each side of the thus prepared polyimide laminate, a 18 μm rolled copper foil (BHY-22B-T, Japan Energy Corp.) and Apical 125 NPI (Kaneka Corp.) on top of each copper foil were thermally laminated continuously with a polyimide laminate's tension of 0.4N/cm, lamination temperature of 380° C. and lamination pressure of 196N/cm (20 kgf/cm) at lamination speed 1.5 m/min. The Apical 125NPI was a protective material. By such thermal lamination, flexible copper-clad laminates (FCCLs).

### Examples 1 and 2

According to the preparation of copper-clad laminate 1, FCCLs were prepared, which had the highly heat-resistant polyimides and thermoplastic polyimide layer respectively as shown in Table 1, in which their properties are also shown.

### Examples 3 and 4

According to the preparation of copper-clad laminate 2, FCCLs were prepared, which had the highly heat-resistant polyimides and thermoplastic polyimide layer respectively as shown in Table 1, in which their properties are also shown.

### Comparative Examples 1 and 2

According to the preparation of copper-clad laminate 1, FCCLs were prepared, which had the highly heat-resistant polyimides and thermoplastic polyimide layer respectively as shown in Table 1, in which their properties are also shown.

### Comparative Examples 3 and 4

According to the preparation of copper-clad laminate 2, FCCLs were prepared, which had the highly heat-resistant polyimides and thermoplastic polyimide layer respectively as shown in Table 1, in which their properties are also shown.

TABLE 1

| | | | | Adhesion Strength (N/cm) | | |
|---|---|---|---|---|---|---|
| | | | | | | 121° C. × |
| | | | | | 150° C. × | 100% RH × |
| | PSE | TPL | HPL | N | 168 hr | 96 hr |
| Ex. 1 | P1 | S.E. 1 | S.E. 3 | 9 | 9 | 7 |
| Ex. 2 | P1 | S.E. 2 | S.E. 4 | 9 | 9 | 7 |
| Ex. 3 | P2 | S.E. 1 | S.E. 3 | 14 | 14 | 13 |
| Ex. 4 | P2 | S.E. 2 | S.E. 4 | 14 | 14 | 13 |
| C. Ex. 1 | P1 | S.E. 1 | S.E. 4 | 4 | 2 | 1 |
| C. Ex. 2 | P1 | S.E. 2 | S.E. 3 | 4 | 2 | 1 |
| C. Ex. 3 | P2 | S.E. 1 | S.E. 4 | 6 | 4 | 2 |
| C. Ex. 4 | P2 | S.E. 2 | S.E. 3 | 6 | 4 | 2 |

Abbreviation:
PSE: Preparation method for sample to be evaluated.
TPL: Thermoplastic Polyimide Layer
HPL: Highly heat-resistant Polyimide Layer
N: Normal Condition
Ex.: Example
C. Ex.: Comparative Example
P1: Preparation method 1
P2: Preparation method 2
S.E.: Synthetic Example

1. A polyimide laminate comprising:
a highly heat-resistant polyimide layer; and
a thermoplastic polyimide layer on at least one side of the highly heat-resistant polyimide layer,
the highly heat-resistant polyimide layer containing molecules of a polyimide having a reactive functional group or reactive functional groups, and
the thermoplastic polyimide layer containing molecules of a thermoplastic polyimide having a reactive functional group or reactive functional groups, each of which is respectively capable of forming a bond with the reactive functional group or reactive functional groups of the polyimide of the highly heat-resistant polyimide layer, each bond being independently at least one bond selected from the group consisting of an imide bond, an amide bond, and a benzimidazole bond.

2. The polyimide laminate as set forth in claim 1, wherein:
each of the reactive functional group or reactive functional groups is a dicarboxylic anhydride group or an amino group, independently.

3. The polyimide laminate as set forth in claim 1, wherein:
each of the polyimides contained in the highly heat-resistant polyimide layer and the thermoplastic polyimide layer have one of the reactive functional group or reactive functional groups at its terminals.

4. The polyimide laminate as set forth in claim 3, wherein:
each of the reactive functional group or reactive functional groups is a dicarboxylic anhydride group or an amino group, independently.

5. The polyimide laminate as set forth in claim 1, containing a polyimide formed by bonding the polyimide contained in the highly heat-resistant polyimide layer with the polyimide contained in the thermoplastic polyimide layer.

6. The polyimide laminate as set forth in claim 5 wherein:
each of the reactive functional group or reactive functional groups is a dicarboxylic anhydride group or an amino group, independently.

7. The polyimide laminate as set forth in claim 5, containing a polyimide formed by bonding a terminal of the polyimide contained in the highly heat-resistant polyimide layer with a terminal of the polyimide contained in the thermoplastic polyimide layer.

8. The polyimide laminate as set forth in claim 7 wherein:
each of the reactive functional group or reactive functional groups is a dicarboxylic anhydride group or an amino group, independently.

9. A method for producing a polyimide laminate by a coextrusion-casting method, the polyimide laminate having a layer of a highly heat-resistant polyimide and a layer of a thermoplastic polyimide on at least one side of the layer of the highly heat-resistant polyimide, the method comprising:
coextruding a solution containing a precursor of the highly heat-resistant polyimide, and a solution containing a precursor of the thermoplastic polyimide in order to cast the solutions onto a supporter,
the precursor of the highly heat-resistant polyimide and the precursor of the thermoplastic polyimide having a reactive functional group or reactive functional groups respectively, each of which is capable of forming a bond therebetween, each bond being independently at least one bond selected from the group consisting of an imide bond, an amide bond, and a benzimidazole bond.

10. The method as set forth in claim 9, wherein:
each of the polyimides contained in the highly heat-resistant polyimide layer and the thermoplastic polyimide layer have one of the reactive functional group or reactive functional groups at its terminals.

11. The method as set forth in claim 9, wherein:
the reactive functional groups of the polyimides contained in the highly heat-resistant polyimide layer and the thermoplastic polyimide layer are capable of forming an imide bond therebetween.

12. A method for producing a polyimide laminate by a coextrusion-casting method, the polyimide laminate having a layer of a highly heat-resistant polyimide and a layer of a thermoplastic polyimide on at least one side of the layer of the highly heat-resistant polyimide, the method comprising:
coextruding a solution containing a precursor of the highly heat-resistant polyimide, and a solution containing the thermoplastic polyimide in order to cast the solutions onto a supporter,
the precursor of the highly heat-resistant polyimide and the thermoplastic polyimide having a reactive functional group or reactive functional groups respectively, each of which is capable of forming a bond therebetween, each bond being independently at least one bond selected from the group consisting of an imide bond, an amide bond, and a benzimidazole bond.

13. The method as set forth in claim 12, wherein:
the reactive functional groups of the polyimides contained in the highly heat-resistant polyimide layer and the thermoplastic polyimide layer are capable of forming an imide bond therebetween.
